(19) United States
(12) Patent Application Publication
(10) Pub. No.: US 2007/0114421 A1
(43) Pub. Date: May 24, 2007

(54) Gas Sensor Array with a Light Channel in the Form of a Conical Section Rotational Member

(76) Inventors: Reinhold Maehlich, Munchen (DE); Rudi Minuth, Freising (DE)

Correspondence Address: BARLEY SNYDER, LLC, 1000 WESTLAKES DRIVE, SUITE 275, BERWYN, PA, 19312, US

(21) Appl. No.: 11/561,917

(22) Filed: Nov. 21, 2006

(30) Foreign Application Priority Data
Nov. 23, 2005 (DE) 102005055860.7

(51) Int. Cl. G01J 5/02

(52) U.S. Cl. 250/343

(57) ABSTRACT

A gas sensor array includes a housing having a gas measuring chamber. A detector at least partially arranged in the gas measuring chamber measures radiation and generates an output signal as a function of the measured radiation. The detector is arranged on a main axis of the housing. Radiation sources are at least partially arranged in the gas measuring chamber and direct radiation toward the detector. The radiation sources are arranged symmetrically to the main axis at a first focal point and have the same effective radiation path length to the detector. The gas measuring chamber has at least one concave mirror formed by inner walls of the housing. The inner walls form a rotational member produced by a conical section and are configured to bundle the radiation emitted from the radiation source at a second focal point proximate the detector.

### FIELD OF THE INVENTION

The present invention relates to a gas sensor array with at least one radiation source emitting radiation, a gas measuring chamber or light channel, which can be filled with a measuring gas that contains at least one analyte to be measured, and at least one radiation detector, which generates an output signal dependent on the presence and/or concentration of the analyte. In particular, the present invention relates to a miniaturized gas sensor array having the above-described elements that can be used, for example, in motor vehicles.

### BACKGROUND OF THE INVENTION

Gas sensor arrays are known for the detection of a wide range of analytes, for example, methane or carbon dioxide, and are disclosed, for example, in European patent application EP 1 566 626 A1. These gas sensor arrays are based on the idea that many polyatomic gases absorb radiation, in particular in the infrared wavelength range. Such absorption occurs in a wavelength characteristic for the relevant gas, for example, at 4.24 μm in the case of carbon dioxide. With the help of such infrared gas sensors it is thus possible to determine the presence of a gas component and/or the concentration of this gas component.

Gas sensor arrays normally have a source of radiation, a gas measuring chamber or light channel, and a radiation detector. The intensity of radiation measured by the radiation detector is an indication of the concentration of the absorbing gas in the gas measuring chamber. It is either possible to use a broadband source of radiation with the wavelength of interest being adjusted via an interference filter or grid, or it is possible to use a selective source of radiation, for example a light-emitting diode (LED) or a laser, in combination with non wavelength-selective radiation receivers.

The detection of carbon dioxide is becoming increasingly important in the motor vehicle sector. This is partly due to the fact that in motor vehicles the carbon dioxide content of the interior air is monitored to increase energy efficiency in heating and air-conditioning. For example, when a high carbon dioxide concentration is detected, a supply of fresh air is initiated via a corresponding air vent control system. In modem air-conditioning systems, which are based on carbon dioxide as a coolant, on the other hand, the carbon dioxide gas sensors perform a monitoring function in association with escaping carbon dioxide in the event of possible defects. However, such sensors must satisfy extremely stringent requirements in terms of robustness, reliability, and above all size, especially in the motor vehicle sector.

In European patent application EP 1 566 626 A1, it is known that the detector and the radiation source are arranged in a housing in such a manner that inner surfaces of this housing, which are equipped with a reflective coating, form a light channel directing the light to the detector. Each radiation source is assigned a separate light channel formed by a hemispherical concave mirror and a tube. However, the array shown in this application has the disadvantage that the light efficiency is comparably low in the range of the maximum permissible angle of incidence diverging from a main axis of the detector.

### BRIEF SUMMARY OF THE INVENTION

It is therefore an object of the present invention to provide a gas sensor array of the type specified above, which has an increased light efficiency and the highest possible selectivity while still being compact and low-cost to manufacture.

This and other objects are achieved by a gas sensor array comprising a housing having a gas measuring chamber. A detector at least partially arranged in the gas measuring chamber measures radiation and generates an output signal as a function of the measured radiation. The detector is arranged on a main axis of the housing. Radiation sources are at least partially arranged in the gas measuring chamber and direct radiation toward the detector. The radiation sources are arranged symmetrically to the main axis at a first focal point and have the same effective radiation path length to the detector. The gas measuring chamber has at least one concave mirror formed by inner walls of the housing. The inner walls form a rotational member produced by a conical section and are configured to bundle the radiation emitted from the radiation source at a second focal point proximate the detector.

This and other objects are achieved by a gas sensor array comprising a housing having a gas measuring chamber. A detector at least partially arranged in the gas measuring chamber measures radiation and generates an output signal as a function of the measured radiation. At least one radiation source at least partially arranged in the gas measuring chamber directs radiation toward the detector. The gas measuring chamber has at least one concave mirror formed by inner walls of the housing. The inner walls form a rotational member produced by a conical section and are configured to bundle the radiation emitted from the radiation source at a focal point proximate the detector.

### BRIEF DESCRIPTION OF THE DRAWINGS

FIG. 1 is a sectional view of a gas sensor array according to a first embodiment of the invention;

FIG. 2 is a perspective view of a first half of a housing of the gas sensor array of FIG. 1;

FIG. 3 is a top schematic view of the gas sensor array of FIG. 1;

FIG. 4 is a partially cut away perspective view of a gas sensor array according to a second embodiment of the invention;

FIG. 5 is a partially cut away perspective view of the gas sensor array of FIG. 4 showing the light rays;

FIG. 6 is a sectional view of the gas sensor array of FIG. 4;

FIG. 7 is a top schematic view of the gas sensor array of FIG. 4;

FIG. 8 is a diagrammatic view of the path of the light rays in a gas measuring chamber in the form of a rotational ellipsoid; and

FIG. 9 is a diagrammatic view of the path of the light rays in a gas measuring chamber partially in the form of a rotational paraboloid.

### DETAILED DESCRIPTION OF THE INVENTION

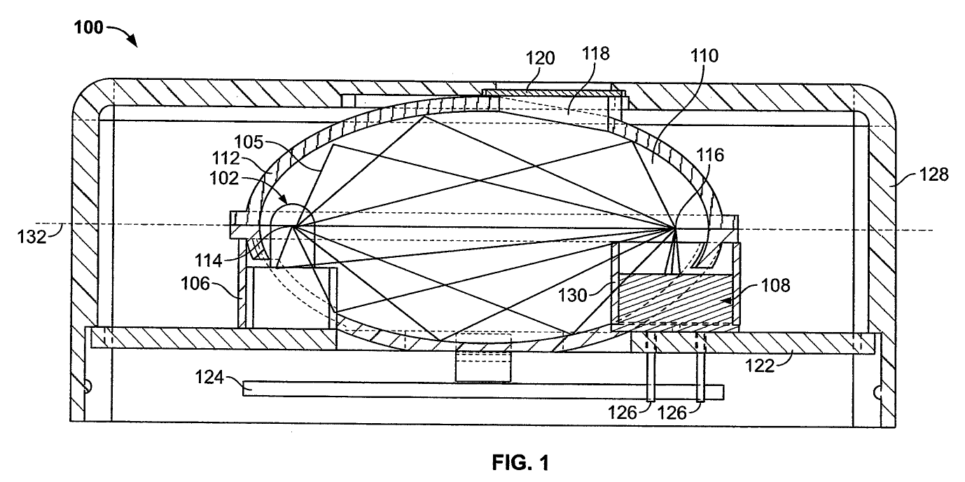

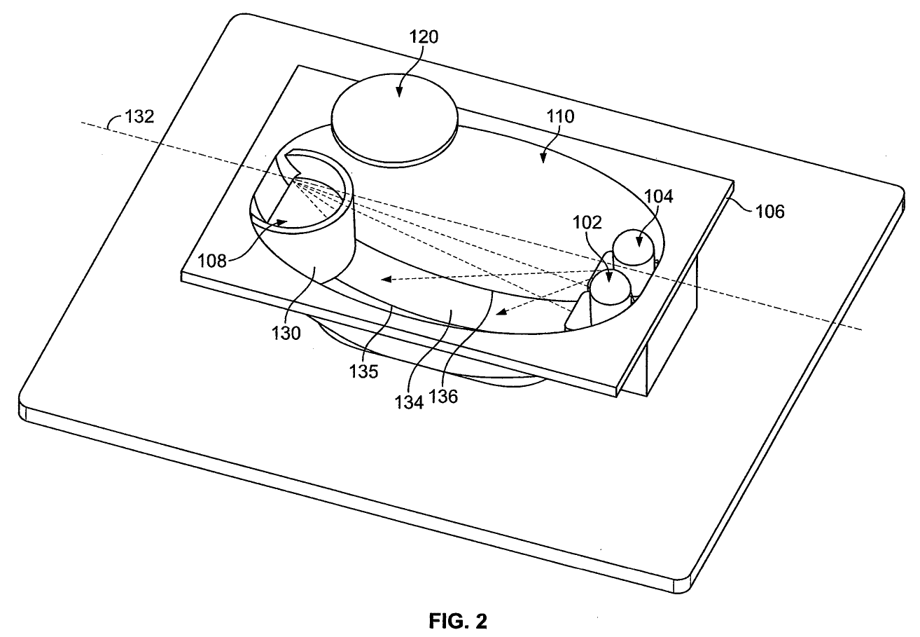

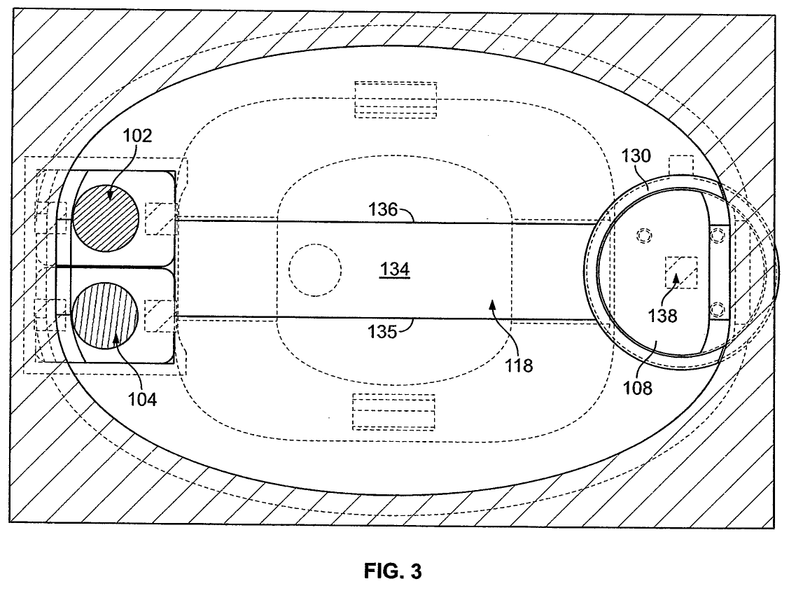

FIGS. 1-3 show a gas sensor array 100 according to a first embodiment of the invention. As shown in FIG. 1, the gas sensor array 100 comprises a housing consisting of a first half 106 joined with a second half 112. The housing may be formed, for example, from a plastic material using injection-molding. As shown in FIG. 2, infrared radiation sources 102, 104 are arranged in the first half 106 of the housing. The radiation sources 102, 104 may be, for example, lamps that emit broadband light spectrums or light-emitting diodes (LED), whereby the latter has the advantage that it is possible to dispense with filter arrays for wavelength selection. The radiation sources 102, 104 directs radiation or light rays 105 toward a detector 108 arranged in the first half 106 of the housing. The detector 108 may be, for example, a pyrodetector, which evaluates incoming radiation and supplies an electrical output signal as a function of the measured radiation. The detector 108 is provided with a shield 130 and a sensor 138 (FIG. 3). The sensor 138 is positioned substantially parallel to a main axis 132 of the housing. It will be appreciated by those skilled in the art that although two radiation sources and one detector are shown in the illustrated embodiment, any number of radiation sources and/or detectors may be used.

The radiation sources 102, 104 may consist, for example, of a measuring radiation source and a reference radiation source, which operate on a differential measuring principle. The radiation sources 102, 104 are arranged symmetrically to the main axis 132 and the detector 108 is arranged on the main axis 132 in such a manner that the paths of the light rays 105 of the radiation sources 102, 104 have the same effective radiation path length to the detector 108. Such a gas sensor array 100 array can be operated, for example, in such a manner that, as disclosed in German patent specification DE 199 25 196 C2, the reference radiation source is switched on at periodic intervals to check the ageing condition of the radiation source. Deviations in relation to the output signals of the detector 108 with the reference radiation source switched on and the measuring radiation source switched off provide information about ageing of the measuring radiation source and this can be compensated for as appropriate. This provides for a marked increase in the reliability and service life of the gas sensor array 100 particularly in the motor vehicle sector.

As shown in FIG. 1, the first half 106, which includes the radiation sources 102, 104 and the detector 108, is arranged on a first printed circuit board 122. Terminals 126 extend from the detector 108 and are electrically connected to signal evaluation electronics arranged on a second printed circuit board 124. The second half 112 of the housing is provided with a gas inlet 118. The gas inlet 188 is equipped with a filter 120 configured for removing particles of dirt.

As shown in FIG. 1, an external housing 128 surrounds the first and second halves 106, 112 and the first and second printed circuit boards 122, 124. The external housing 128 protects the entire gas sensor array 100 from dust, environmental influences, and undesirable scattered light. The external housing 128 allows the first and second halves 106, 112 of the housing to be manufactured with much thinner walls, as the mechanical stability is ensured by the external housing 128. It is, however, possible to form the gas sensor array 100 without the external housing 128.

As shown in FIG. 1, inner walls of the first and second halves 106, 112 form a light channel or gas measuring chamber 110. In the illustrated embodiment, the inner walls of the gas measuring chamber 110 form a rotational ellipsoid. A gas containing an analyte, such as carbon dioxide, is contained in the gas measuring chamber 110. The intensity of the radiation reaching the detector 108 depends on the composition of the gas contained in the gas measuring chamber 110. The inner walls are coated with a reflective material. The reflective material may be, for example, a metal such as gold and may be deposited on the inner walls by, for example, sputtering, vapor-depositing, or electroplating. The inner walls thereby form a concave mirror and at least partially take the form of a rotational member produced by a conical section, which is designed in such a manner as to result in bundling of the light rays 105 at a region in which the detector 108 is arranged. The radiation sources 102, 104 are arranged at a first focal point 114. The detector 108 is arranged proximate a second focal point 116. As can be seen from the course of the light rays 105, in accordance with the laws of optics, the shape of the gas measuring chamber 110 greatly improves bundling of the light rays 105 at the detector 108. At the second focal point 116, a tilted mirror (not shown) is provided that is positioned and configured to direct the light rays 105 to the sensor 138 of the detector 108. The tilted mirror (not shown) may be, for example, aligned parallel to the main axis 132 of the housing. Alternatively, the detector 108 may be installed crosswise to the main axis 132 of the housing. A temperature sensor (not shown) may be provided for monitoring the temperature in the gas measuring chamber.

To ensure that each of the radiation sources 102, 104 is arranged at the first focal point 114, a connecting region 134 is provided between the detector 108 and the radiation sources 102, 104. The connecting region 134 extends between the radiation sources 102, 104 and the detector 108 and follows the curvature of the inner walls of the gas measuring chamber 110 in the direction of the main axis 132, but is not curved transverse to the direction of the main axis 132. In the embodiment shown, longitudinal limits 135, 136 of the connecting region 134 run substantially parallel to each other and the path of the light rays 105 of the two radiation sources 102, 104 also run substantially parallel to each other. A flat projection of the connecting region 134 has a substantially rectangular shape.

It can generally be demonstrated that for clear separation of the various frequency ranges of the radiation sources 102, 104, only the proportion of the light rays 105 deviating from 0 degrees to a maximum permissible angle of incidence from the main axis 132 should be evaluated. This maximum permissible angle of incidence depends on such factors as, for example, the choice of the wavelength-selective filter before the detector 108, which is selected according to the light frequency of interest depending on the analyte to be detected. In the case of the gas sensor array 100 shown, the maximum permissible angle of incidence is, for example, approximately 20 degrees, although other values are also possible. For this reason, in the embodiment shown in FIG. 1, the detector 108 is provided with the shield 130, which prevents the incidence of the light rays 105 deviating more than about 20 degrees from the main axis 132. In other words, the shield 130 is arranged around the detector 108 so that only the light rays 105 deviating between 0 degrees and approximately 20 degrees from the main axis 132 reach the detector 108. However, other values for the maximum permissible angle of incidence are likewise possible as already mentioned, depending on the gas component to be detected. It is also possible to dispense with the shield 130.

According to the first embodiment shown in FIGS. 1-4, the radiation sources 102, 104 are arranged next to each other and the longitudinal limits 135, 136 of the connecting region 134 extend substantially parallel to each other. Each of the radiation sources 102, 104 is thus located on one half of the first focal point 114 of the rotational ellipsoid of the gas measuring chamber 110 associated therewith. This variant represents a solution that is very simple to perform on assembly but has the disadvantage that bundling in the sensor 138 takes place at two places at the second focal point 116.

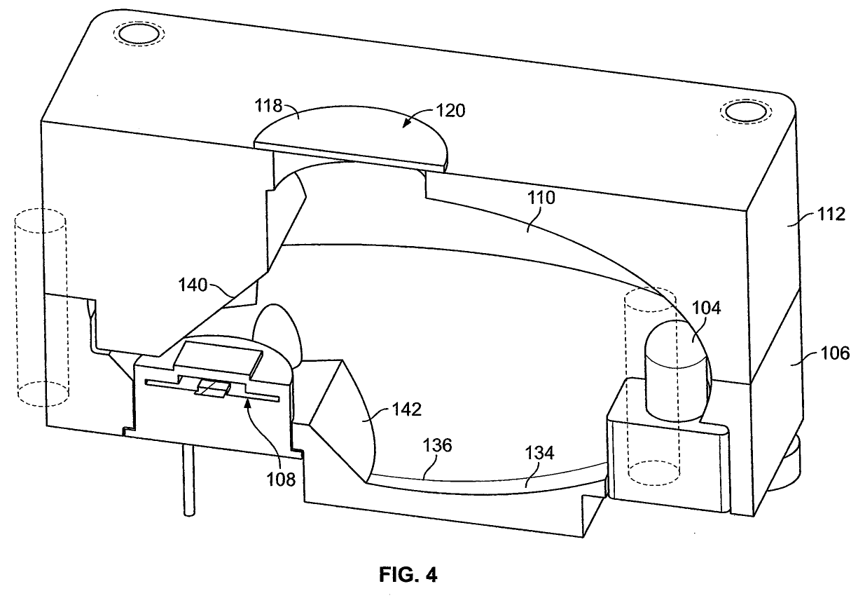

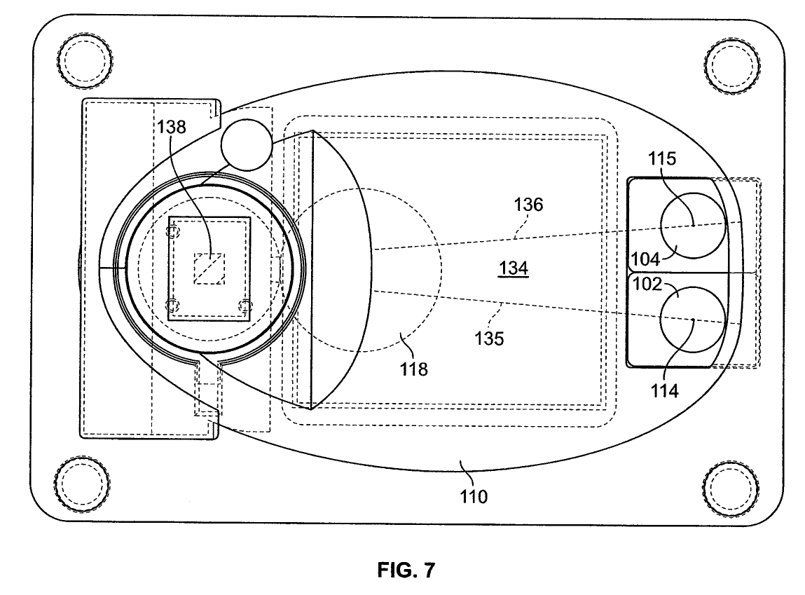

FIGS. 4-7 show a second embodiment of a gas sensor array 100 according to the invention, which improves upon the gas sensor array 100 according to the first embodiment of the invention. As shown in FIG. 7, in the gas sensor array 100 according to the second embodiment, the connecting region 134 is formed so that the longitudinal limits 135, 136 of the connecting region 134 enclose an angle corresponding to an angle enclosed by center lines of the radiation sources 102, 104. In other words, the connecting region 134 has longitudinal limits 135, 136 corresponding to a center line extending between each of the radiation sources 102, 104 and the detector 108. This produces two rotationally elliptical regions of the gas measuring chamber 110, which have different first focal points 114, 115 but only one second focal point 116, which is located at the detector 108. A flat projection of the connecting region 134 has a substantially trapezoidal shape.

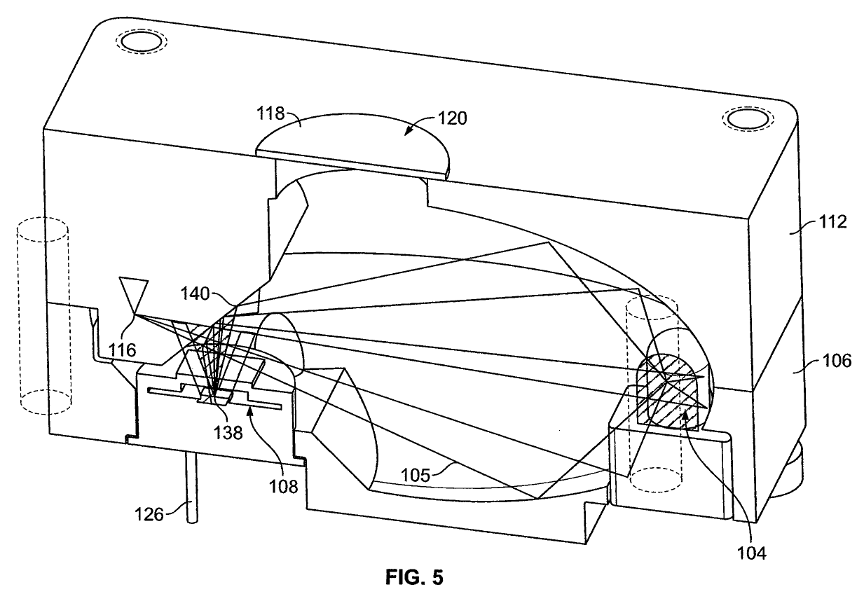

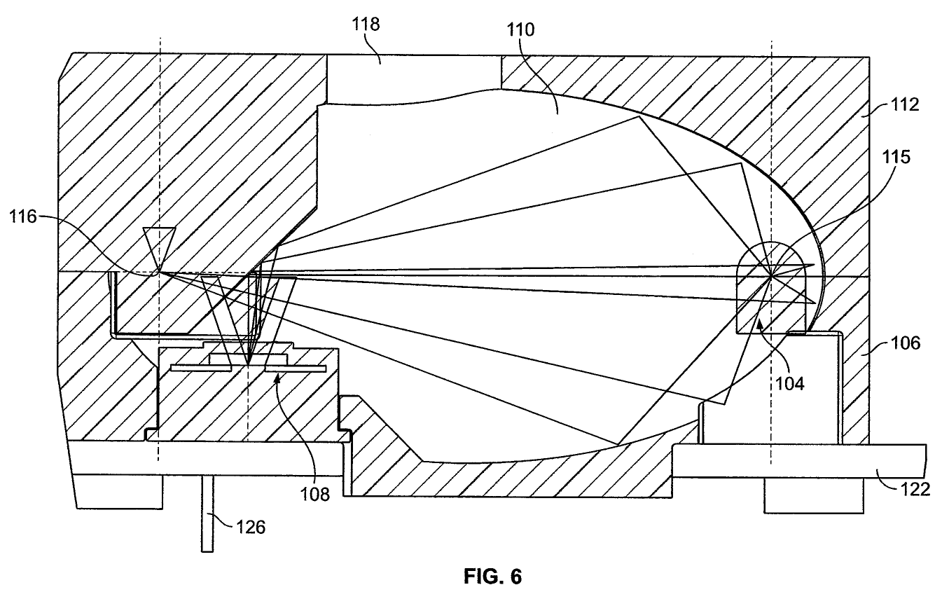

As shown in FIG. 4, the inner walls of the gas measuring chamber 110 only partially take the form of a rotational ellipsoid. A substantially flat tilted mirror 140 is arranged at the second focal point 116 of the rotational ellipsoid. The tilted mirror 140 can be manufactured as a single piece from the first and second halves 106, 112 of the housing by applying a metal coating to the first and second halves 106, 112 of the housing. As shown in FIGS. 5-6, the tilted mirror 140 is arranged above the detector 108 so that the light rays 105, which arrive at the second focal point 116, are focused on the sensor 138. To clarify the functional principle, both the real and the virtual paths of the light rays 105 are shown in FIGS. 5-6. The second focal point 116 is therefore a virtual focal point, whereas the light rays 105 for the embodiment shown in FIGS. 1-3 also actually meet at the second focal point 116, which is a real focal point.

As shown in FIG. 4, another tilted mirror 142 is provided in a region below the detector 108. This tilted mirror 142 deflects the light rays 105 striking it to the opposite rotationally elliptical inner wall from where the radiation can then be focused on the tilted mirror 140. The tilted mirror 142 thus further increases light efficiency.

The assembly of the gas sensor array 100 will now be described. The detector 108 and the radiation sources 102, 104 are mounted on the first printed circuit board 122. The second printed circuit board 124, on which other electronic components are mounted, such as those required for sensor signal evaluation and control of the infrared radiation sources, is connected to the terminals 126 of the detector 108 and accordingly also to the radiation sources 102, 104.

The first half 106 of the housing is mounted on the first printed circuit board 122 so that the radiation sources 102, 104 and the detector 108 are held in corresponding recesses. To ensure overall installation space for geometrical extension of the measuring chamber 110 crosswise to the main axis 132, a corresponding opening, into which the measuring chamber 110 can reach, is provided in the first printed circuit board 122.

The second half 112 of the housing is positioned on the first half 106 of the housing and fixed in place, for example, using a screwed connection. If necessary, the external housing 128 can also be provided to ensure additional protection from mechanical stress and the penetration of scattered light that may cause interference. As shown in FIGS. 4-7, the external housing 128 may also be integrally formed with the first and second half halves 106, 112 of the housing. Although such integration of the first and second halves 106, 112 and the external housing 128 requires more material and thus also increases the weight of the housing, it simplifies the manufacturing process to a significant extent and also offers very high mechanical stability. A boundary layer between the first half 106 and the second half 112 of the housing may optionally be sealed with a suitable sealing device, as taught in EP 1 566 626 A1.

The present invention makes it possible to provide an optimized light channel, which is simple and provides a much greater light efficiency. By reducing the proportion of light outside the maximum permissible angle of incidence with reference to the main axis 132, it is also possible to achieve a clearer separation of various frequency ranges. The gas sensor array 100 according to the invention is therefore suitable for use in motor vehicles sector.

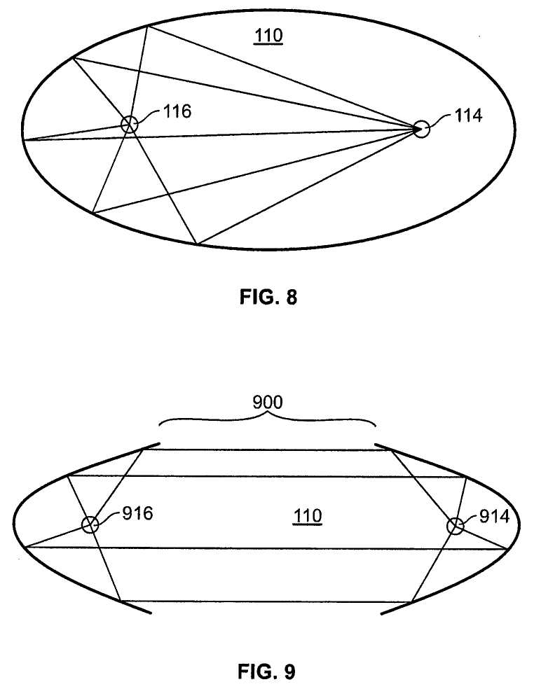

Although FIGS. 1-7 illustrate a rotationally elliptical design of the gas measuring chamber 110, it is also possible to use other conical sections to produce the gas measuring chamber 110. FIGS. 8-9 show, for example, a diagrammatic comparison of the direction of the light rays 105 for a rotational ellipsoid (FIG. 8) where the inner walls of the gas measuring chamber 110 take the form of a rotational paraboloid. According to FIG. 9, two parabolic mirrors are set up facing each other so that this embodiment also results in bundling of the radiation emitted at the first focal point 914 at a second focal point 916 at which the detector 108 can be arranged. One of the advantages of such a design is that a region of a parallel ray path 900 can be selected in terms of length according to the requirements placed on the sensitivity of the gas sensor array 100. With very low detection limits, it may be necessary to extend the optical path length through the gas measuring chamber 110 to generate a sufficiently great detection signal.

The present invention is based on the fundamental idea that light efficiency can be significantly increased with simple geometry of the gas measuring chamber 110 and an array of components suitable for production when a housing containing the radiation sources 102, 104, the gas measuring chamber 110 and the detector 108 has reflective inner walls, which form a concave mirror and at least partially take the form of a rotational member produced by a conical section, which is designed in such a manner as to result in bundling of the light rays 105 emitted at a region in which the detector 108 is arranged. In this way, a much greater light efficiency can be achieved with the same radiation source intensity. In addition, the proportion of light outside the maximum permissible angle of incidence can be reduced, thus allowing the various frequency ranges to be separated more clearly from each other. Here, the maximum permissible angle of incidence depends on such factors as the choice of the filter arranged before the detector 108 and may be about 20 degrees, for example. In terms of production technology such a housing shape can be manufactured with comparably simple tools.

The rotational member can be formed by a rotational member produced by a conical section such as a rotational ellipsoid, a rotational paraboloid or a rotational hyperboloid and also by parts of these bodies. In the geometrically simplest case, the radiation sources 102, 104 are located at the first focal point 114 of a rotational ellipsoid, while the detector 108 is located at the second focal point 116 of the rotational ellipsoid on which the radiation emitted by the radiation sources 102, 104 is focused. This gas sensor array 100, however, has the disadvantage that the sensor 138 of the detector 108 has to be aligned crosswise to the main axis 132 of the housing and thus cannot be simply mounted on the same first printed circuit board 122 as the radiation sources 102, 104. According to an advantageous development of the present invention, it is thus possible to provide, in addition to the rotationally elliptical shape of the gas measuring chamber, for the at least one tilted mirror 140 which deflects the bundled radiation once again so that it strikes the sensor 138 of the detector 108. The tilted mirror 140 is preferably designed as a flat mirror. It is, however, clear that another concave mirror can also be provided if needed.

The gas sensor array according to the invention can be integrated in electronic systems in a particularly space-saving manner where it is designed so that it can be mounted on the printed circuit board as a module. This also offers the advantage that the necessary evaluation electronics, which, for example, are used for further processing of the output signal generated by the detector 108, can be installed on the same printed circuit board.

The radiation sources 102, 104 are arranged so that they are positioned substantially next to each other and their light ray paths only enclose a comparably small angle. Thus, manufacture of the gas sensor array 100 can be simplified to a marked extent. In order to achieve the greatest possible bundling of the respective radiation at the detector 108, the rotationally elliptical form of the gas measuring chamber 110 can be interrupted by the connecting region 134 between the radiation sources 102, 104 and the detector 108. This connecting region 134, according to the first embodiment, is shaped as part of an elliptical cylinder jacket, which in a longitudinal direction, i.e. in the direction of the connection between The radiation sources 102, 104 and the detector 108, follows the curvature of the rotational ellipsoid but is not curved in a transversal direction, a flat projection of this connecting region 134 being rectangular. In this way, each of the radiation sources 102, 104 is located at the focal point of the rotationally ellipsoidal inner surface of the housing closest to it and its radiation is bundled particularly effectively.

The disadvantage of this gas sensor array 100 is, however, that two second focal points 116 likewise occur at the site of the detector 108. To overcome this disadvantage, according to a second embodiment, the inner walls of the housing can be designed in such a manner that the connecting region 134 in the form of an elliptical cylinder jacket has a trapezoidal flat projection. Thus, each of the radiation sources 102, 104 is then located at the first focal point 114, 115 of the half of the rotational ellipsoid assigned thereto while the second focal points 116 coincide and lie on the sensor 138 of the detector 108.

The advantageous properties of the gas sensor array 100 according to the invention are particularly useful for the detection of carbon dioxide, for example, in the motor vehicle sector, and for monitoring carbon dioxide leaks as well as for checking the air quality in an interior of a vehicle. However, the gas sensor array 100 according to the invention can of course also be used for the detection of any other gases.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A gas sensor array, comprising:
a housing having a gas measuring chamber;
a detector at least partially arranged in the gas measuring chamber that measures radiation and generates an output signal as a function of the measured radiation;
at least one radiation source at least partially arranged in the gas measuring chamber that directs radiation toward the detector; and
the gas measuring chamber having at least one concave mirror formed by inner walls of the housing, the inner walls forming a rotational member produced by a conical section and being configured to bundle the radiation emitted from the radiation source at a focal point proximate the detector.

2. The gas sensor array of claim 1, wherein the rotational member is an ellipsoid.

3. The gas sensor array of claim 1, wherein the inner walls are coated with a reflective material.

4. The gas sensor array of claim 1, further comprising at least one flat tilted mirror at the focal point, the tilted mirror being configured to deflect the bundled radiation onto a sensor of the detector.

5. The gas sensor array of claim 1, wherein the housing is formed by a first half and a second half that are joined together to form the gas measuring chamber.

6. The gas sensor array of claim 1, further comprising an external housing surrounding the housing.

7. The gas sensor array of claim 1, wherein the housing is mounted on a first printed circuit board.

8. The gas sensor array of claim 1, wherein the radiation source is an infrared radiation source.

9. A gas sensor array, comprising:
a housing having a gas measuring chamber;
a detector at least partially arranged in the gas measuring chamber that measures radiation and generates an output signal as a function of the measured radiation, the detector being arranged on a main axis of the housing;
radiation sources at least partially arranged in the gas measuring chamber that direct radiation toward the detector, the radiation sources being arranged symmetrically to the main axis at a first focal point and having the same effective radiation path length to the detector; and
the gas measuring chamber having at least one concave mirror formed by inner walls of the housing, the inner walls forming a rotational member produced by a conical section and being configured to bundle the radiation emitted from the radiation source at a second focal point proximate the detector.

10. The gas sensor array of claim 9, wherein the rotational member is an ellipsoid.

11. The gas sensor array of claim 9, wherein the inner walls are coated with a reflective material.

12. The gas sensor array of claim 9, further comprising at least one flat tilted mirror at the second focal point, the tilted mirror being configured to deflect the bundled radiation onto a sensor of the detector.

13. The gas sensor array of claim 9, wherein the housing is formed by a first half and a second half that are joined together to form the gas measuring chamber.

14. The gas sensor array of claim 9, further comprising an external housing surrounding the housing.

15. The gas sensor array of claim 9, wherein the housing is mounted on a first printed circuit board.

16. The gas sensor array of claim 9, wherein the radiation sources are infrared radiation sources.

17. The gas sensor array of claim 9, wherein a connecting region extends between the detector and the radiation sources that follows the curvature of the inner walls in a direction of the main axis, the connecting region having longitudinal limits extending parallel to each other.

18. The gas sensor array of claim 9, wherein a connecting region extends between the detector and the radiation sources that follows the curvature of the inner walls in a direction of the main axis, the connecting region having longitudinal limits corresponding to a center line extending between each of the radiation sources and the detector.

19. The gas sensor array of claim 9, wherein the detector includes a shield configured to allow only radiation deviating from between 0 degrees and approximately 20 degrees from the main axis from reaching the detector.
